(19) United States
(12) Patent Application Publication
(10) Pub. No.: US 2015/0186329 A1
(43) Pub. Date: Jul. 2, 2015

(54) System and Method for Simplified Input Specification, and Output Request, of Cash Flow Annuity Streams characterized by a Non-Zero, Constant Growth Rate, as an aid in Financial Computations.

(71) Applicant: Larry Raymond Gorman, Pismo Beach, CA (US)

(72) Inventor: Larry Raymond Gorman, Pismo Beach, CA (US)

(21) Appl. No.: 14/579,553

(22) Filed: Dec. 22, 2014

Related U.S. Application Data
(60) Provisional application No. 61/921,477, filed on Dec. 29, 2013.

(51) Int. Cl. G06F 15/02; G06Q 40/00

(52) U.S. Cl. CPC G06F 15/0225; G06Q 40/00; G06Q 40/08

(57) ABSTRACT

A system and method for specifying and requesting, the computation of, the constant growth rate of a cash flow annuity stream, as an aid in financial computations. The central focus of the invention is a g-button which is used to either impart or request the growth rate of a specific annuity stream.

### CROSS-REFERENCE TO RELATED APPLICATIONS

Provisional Utility patent filed Dec. 29, 2013: Application No. 61/921,477

### BACKGROUND OF THE INVENTION

The invention is in the field of computational finance, and addresses the specification and determination of the constant growth rate (symbolized as g), of a cash flow annuity stream in existing computational devices such as, but not limited to: Hewlett Packard's HP-12C finance/business handheld calculator, Texas Instruments' BA-II Plus finance/business handheld calculator, internet-based finance/business calculators, applications (“Apps”) designed as business/finance calculators for smart devices such as smart phones, and tablets, and other electronic devices, and associated software in which financial calculations involving zero growth (g=0) annuity streams are performed.

A common problem to which the invention is drawn is shown in FIG. 1 of the drawings. FIG. 1 depicts a finance problem in which the present value of a cash flow annuity-stream is sought. In this problem the n=4 cash flows that comprise the annuity stream are each larger than the prior cash flow by 10%—hence the 4 cash flows which comprise this annuity stream are said to be growing at a rate of 10%, i.e. g=10%.

A critical component of the invention can be described as a “g-button” for specifying the constant growth rate of an annuity stream, which when appended to modern computational devices such as handheld financial calculators (e.g. Texas Instruments BA II Plus, and the HP 12C), or smart device Apps, which already contain:
an “n-button”—for specifying the Number of cash flows in an annuity stream, and
an “A” button (sometimes known as a PMT, or Payment-button)—for specifying the size of the first cash flow in the annuity stream
   allows the user to efficiently specify information that is sufficient to subsequently determine the size of all cash flows that comprise a non-zero constant growth rate annuity stream, such as that shown in FIG. 1. Existing calculators do not include an efficient method for specifying the size, explicitly or implicitly, of all cash flows that comprise a non-zero constant growth rate annuity stream. This inherent inefficiency of existing financial calculators makes them cumbersome to work with when non-zero constant growth rate annuity streams are involved. For example, for the annuity stream depicted in FIG. 1, the specification of the 10% growth rate in conjunction with the knowledge that n=4, and A=100, eliminates the need for specifying the 2^{nd} cash flow of $110, the 3^{rd} cash flow of $121 and the 4^{th} cash flow of $133.1 (a total of 14 keystrokes) and instead requires only 9 keystrokes—a reduction of 35.7%. For annuity streams comprised of a dozen or more cash flows the reduction in keystrokes in dramatic, and can impart a 90% (to >99%) reduction in required keystrokes. The addition of a “g-button” to modern computational devices also reduces the number of required keystrokes when the growth rate, g, is sought as an output (see FIGS. 2 and 4). In fact, for some devices (e.g. Texas Instruments BA II Plus) the solution for g is unavailable without the addition of either a “g-button” or the addition of an internal programming environment (which many financial calculators do not provide). However even with the addition of an internal programming environment, the number of keystrokes required to solve the problem is substantially larger than that required when a “g-button” is available.

The invention was initially publically disclosed on Jan. 4, 2013 in the form of a textbook written by the patent applicant, titled “Mastering the Fundamentals of Finance” and published/distributed by Cognella publishing. The ISBN number of the initial publication is 978-1-62131-399-1. A provisional utility patent was filed Dec. 29, 2013 (Application No. 61/921,477). The current submission is for a non-provisional utility patent. By the time this patent application is reviewed by the patent reviewer, the invention should be available on-line at www.7button.com and it may also be available for purchase for installation on Android and Apple smart devices.

### BRIEF SUMMARY OF THE INVENTION

A cash flow annuity stream (hereafter, an “annuity stream) is traditionally defined as being comprised of an constant frequency, periodic stream of discrete cash flows with a constant growth rate, where the growth rate measures the percentage change in the size (magnitude) of the cash flows that comprise the annuity stream. Traditionally, computational devices that work with annuity streams are only programmed to work with annuity streams that have a constant growth rate of zero, i.e. g=0.

As described earlier, the growth rate of an annuity stream measures the percentage change in the size of the cash flow payments (or receipts) that comprise an annuity stream. For example, a 4 period annuity stream with an initial payment of $100 and a 10% growth rate (i.e. g=10%) is comprised of 4 cash flows of sizes: $100 (1^{st} payment), $110 (2^{nd} payment), $121 (3^{rd} payment), and $133.10 (4^{th} payment). Notice that each payment is 10% larger than the prior, and hence the payments that comprise the 4 period annuity stream are growing at a constant 10% rate per period (g=10%). Growth rates can also be negative (g<0), in the case of shrinking cash flow payments. For example, a 4 period zero annuity stream with an initial cash flow of $100 and a constant growth rate of −20% is comprised of 4 cash flows of sizes: $100 (1^{st} payment), $80 (2^{nd} payment), $64 (3^{rd} payment), and $51.20 (4^{th} payment). Annuity growth rates can also be equal to zero (g=0). For example, a 4 period zero growth (g=0) annuity stream with an initial cash flow of $100 is comprised of 4 cash flows of sizes: $100 (1^{st} payment), $100 (2^{nd} payment), $100 (3^{rd} payment), and $100 (4^{th} payment). Since the cash flows that comprise this annuity stream are neither growing, nor shrinking, the growth rate is 0%.

The invention is focused on the analysis of annuity streams with non-zero growth rates, i.e. g>0 and g<0. Annuity streams with non-zero growth rates are common, and of much interest to financial analysts. For example, consider Mr. X who wishes to borrow $10,000 in order to buy a car. If the annual interest rate on the loan is 6% APR, then the appropriate monthly rate is 0.50% per month (=6%/12). In this case the 48 payments comprise an annuity stream in which each monthly payment of $234.85 is the same size (g=0). However, if the same problem is viewed in terms of inflation adjusted (real) terms, then the annuity stream is NOT described as g=0. Rather, if inflation is estimated to be 3% per year, equivalent to 0.25% per month (=3%/12) then the purchasing power of the periodic $234.85 payments is declining in real terms (g^{real}<0). Hence, even the ubiquitous car loan problem, which is often viewed as g=0, can be thought of in inflation adjusted terms as a shrinking (g<0) annuity. In this example, the real growth rate, g^{real}, is approximately −0.2493766%—computed as

$${g}^{real} = \frac{1}{1.0025} - 1.$$

As another example, consider a wealthy benefactor who wishes to make a donation of $1 million to a local charity. The benefactor invests the money in a saving account earning 5% per year, and desires that a total of ten annual payments be withdrawn from the savings account and paid to the charity in order to help fund their operations. In order to offset the impact of inflation, estimated to be 3% per year, the benefactor requires that each of the ten payments (which comprise an annuity stream) be larger than the prior by 3%, i.e. g=3%. This too is a common situation, and involves non-zero growth rates (g≠0).

Finance problems involving annuity steams can be partitioned into two types of problems. (1) Problems in which the constant growth rate is known (and is specified as in input) and another financial variable (such as present value, PV) is requested as the output/solution, and (2) problems in which all other relevant financial variables (other than g) are known, and the requested output is the growth rate, g, of the annuity stream. For existing financial calculators (which are void of a g-button) both types of problems typically involve a substantial number of keystrokes when non-zero growth rate annuities are involved.

Modern handheld financial calculators, such as the Hewlett Packard HP 12-C, and the Texas Instruments BA-II Plus, are not designed to work efficiently with annuity streams that involve non-zero growth rates. In all modes of operation, they assume the growth rate of any annuity stream is always zero (g=0).

The limited functionality of modern computational devices that are designed to assist in financial analysis stems from a limited “five button” design in which the growth rate of an annuity stream is always assumed to be zero. For example, modern handheld calculators, and smart device Apps are focused around five buttons, each of which represent a financial variable. For example, on the HP 12-C, the five buttons are labeled: “n” for number of periods, “i” for interest rate, “PV” for present value, “PMT” for the size of the first payment in the annuity stream, and “FV” for the future value. The invention would augment these five buttons with a sixth button labeled “g” for the constant growth rate of the annuity stream.

The addition of the sixth “g-button” allows for a substantial—often dramatic—reduction in the number of keystrokes when working with non-zero growth rate annuities. The keystroke reduction occurs because the g-button allows the efficient specification of each (of typically many) cash flows that comprise the annuity stream. For non-zero growth annuity streams, each cash flow within the annuity stream is unique. Without a g-button, each of these cash flows must be specified (via multiple keystrokes) individually. In addition, a g-button allows the user to solve for the growth rate, g, as an output when otherwise the computational device is either:
(i) totally incapable of solving for the growth rate (e.g. the Texas Instruments BA-II Plus handheld calculator), or
(ii) obtaining a solution for the growth rate requires both the availability of an internal programming environment (such as that available in the HP 12-C's PRGM-mode, but not available in the Texas Instruments BA-II Plus), and rather extensive, customized programming entered by the user, which involves many keystrokes.

In brief, the invention can be implemented via appending a sixth “g-button” to modern financial calculators (including smart device Apps) which are currently based around five buttons (commonly labeled as: n, i, PV, PMT and FV). The proposed “g-button” allows for a substantial reduction in keystrokes in both specifying and solving for the constant growth rate of an annuity stream. In addition, for computational devices that are void of a programming environment (such as the Texas Instruments BA-II Plus handheld calculator, and many smart device Apps) the invention provides the capability to solve for the growth rate of an annuity stream—where otherwise the solution for the growth rate is not obtainable. Even when a device is capable of solving for the growth rate (such as with HP's 12-C hand held calculator—which include the capability of writing customized programs)—the inclusion of a “g-button” greatly simplifies the process from dozens, and possibly hundreds of keystrokes (via writing custom and often complex code) to just two keystrokes: (i) Hit the “Solve For” button, and (ii) then hit the “g-button.”. In fact the “Solve For” button is optional, and can be eliminated (as is done on some hand held devices, such as the HP 12C) in which case dozens, or possibly hundreds of keystroke are reduced to a single keystroke of: Hit the “g-button.” We include the “Solve For” button in our patent description solely as a means of enhancing the clarity of operation. i.e. the “Solve For” button is completely optional.

For example, for the problem depicted in FIG. 2, the solution for the implied growth rate, g, is easily obtained by the “six button” calculator depicted in FIG. 4—which includes a the traditionally available five buttons, plus a sixth “g-button.” Amongst five button (traditional) financial calculators ONLY those with a internal programming capabilities can solve this problem at all, and even then the number of keystrokes required to solve the problem (via writing customized code) is substantial. The invention of a “g-button” solves the problem in an efficient manner, and the answer is available to any user—even to users who have no programming skills. Note that a “Solve For” button, as shown in FIGS. 3, 4, and 5A to 5E is an optional button that is not needed to operate a financial calculator—although some users find it useful to have one. For example, the HP 12C is void of a “Solve For” button. This patent application makes no claims on using, or not using a “Solve For” button. We include a “Solve For” button in our drawings only to aid the patent reviewer in understanding the operation of a financial calculator.

### BRIEF DESCRIPTION OF THE SEVERAL VIEWS OF THE DRAWINGS

The drawings consist of a total of nine (9) figures. A brief description of each drawing follows:

FIG. 1—a cash flow timeline of a simple annuity stream, growing at 10%, in which the present value is the requested unknown value. Possible calculator based solution approaches are given in FIGS. 3 and 5A to 5E.

FIG. 2—a cash flow timeline of a simple annuity stream, with an unknown growth rate. This timeline is very similar to that of FIG. 1, but instead of g being known (in FIG. 1) g is unknown in FIG. 2. A solution to this problem is given in FIG. 4.

FIG. 3—solution to FIG. 1 using a conventional “five button” calculator, operating in “Simple 5-button mode”—and augmented with the invention of a g-button—which expands the number of buttons from five to six. Here, the growth rate is specified as a (known) input.

FIG. 4—solution to FIG. 2 using a conventional “five button” calculator, operating in “Simple 5-button mode”—and augmented with the invention of a g-button—which expands the number of buttons from five to six. Here, the growth rate is requested as an output.

FIG. 5A. The first input screen for solving the timeline of FIG. 1 when a calculator operates in “Group” mode (commonly known as “CF-j mode” for the HP 12C calculator). FIGS. 5A to 5E demonstrate the “many keystroke” method of solving FIG. 1, whereas FIG. 3 shows the “fewer keystroke” method of solving the same problem (via employing a “g-button” to “Simple 5-button mode”).

FIG. 5B. The second input screen for solving the timeline of FIG. 1 when a calculator operates in “Group” mode FIG. 5C.

The third input screen for solving the timeline of FIG. 1 when a calculator operates in “Group” mode FIG. 5D.

The fourth input screen for solving the timeline of FIG. 1 when a calculator operates in “Group” mode.

FIG. 5E. The final screen for solving the timeline of FIG. 1 when a calculator operates in “Group” mode.

### DETAILED DESCRIPTION OF THE INVENTION

The present invention is a system and method for simplifying the specification (via reducing keystrokes) of all cash flows that comprise an annuity stream when characterized by non-zero constant growth. It also simplifies, and in some cases makes possible, the determination of the implied constant growth rate of an annuity stream. For definition, the constant growth rate of an annuity steam measures the percentage change (or its decimal equivalent) in the size (magnitude) of the multiple cash flows that comprise an annuity stream.

The system and method of the current invention introduces the use of a specific “g-button,” which is used to specify, or request the constant growth rate of the cash flows comprising the annuity stream, and greatly simplifies the complete specification of the problem via a substantial reduction in the keystrokes required to describe and/or solve financial problems involving non-zero, constant growth rate annuities. For virtually all finance problems involving annuity streams, the simplification in terms of reduced keystrokes is substantial for a all handheld financial calculators, such as an Hewlett Packard, model 12C (hereafter: HP 12C), the Texas Instruments BA-II Plus, as well as their web based counterparts and smart device (e.g. iPhone, iPad) “App” equivalents. In addition, many of these devices (specifically, those lacking an internal programming environment) benefit from the invention via expanding their computational capabilities, as mentioned earlier, and portrayed in FIGS. 2 and 4—whereby it is shown that solving for g is trivial with the addition of a g-button (requiring only a single keystroke to request the value of the constant growth rate)—a task that is not even possible for calculators that are void of an internal programming environment, and is very cumbersome (requiring many keystrokes) for those that do include an internal programming environment.

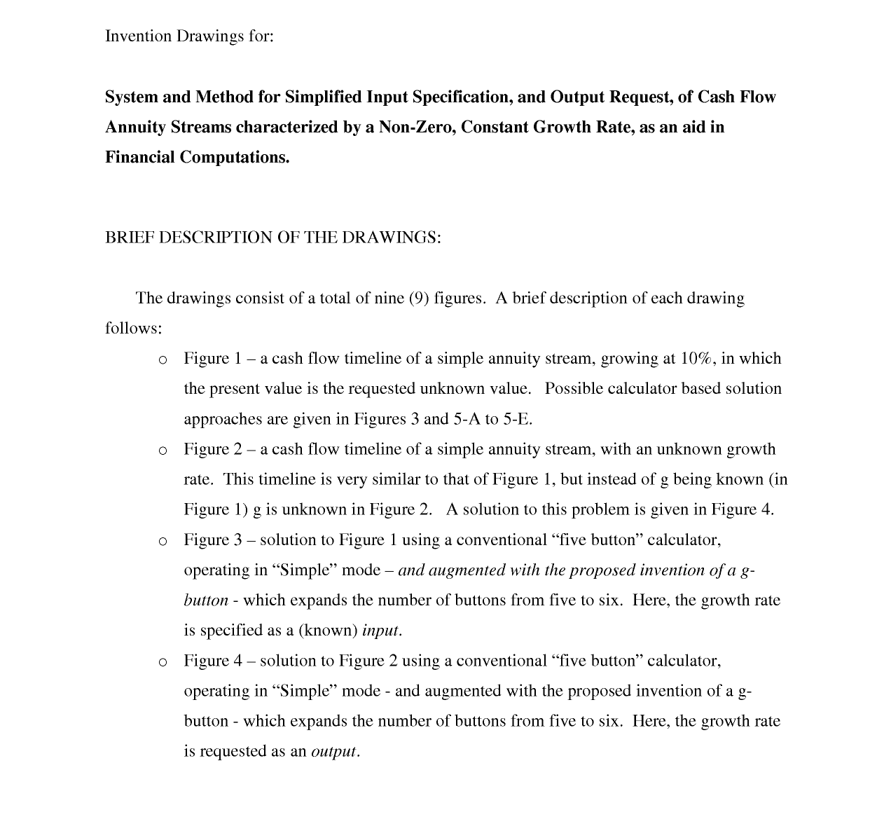

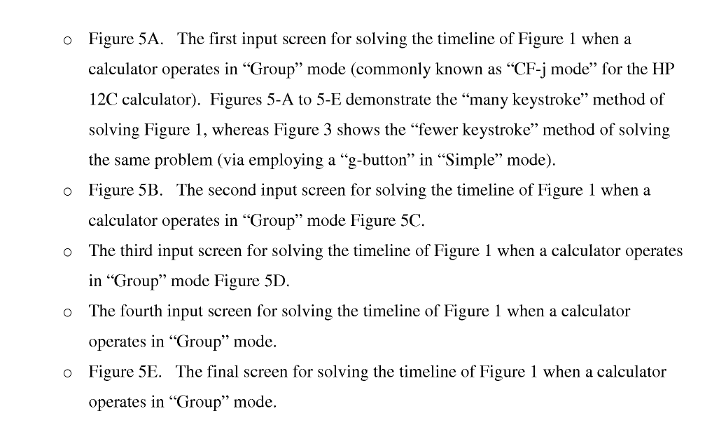

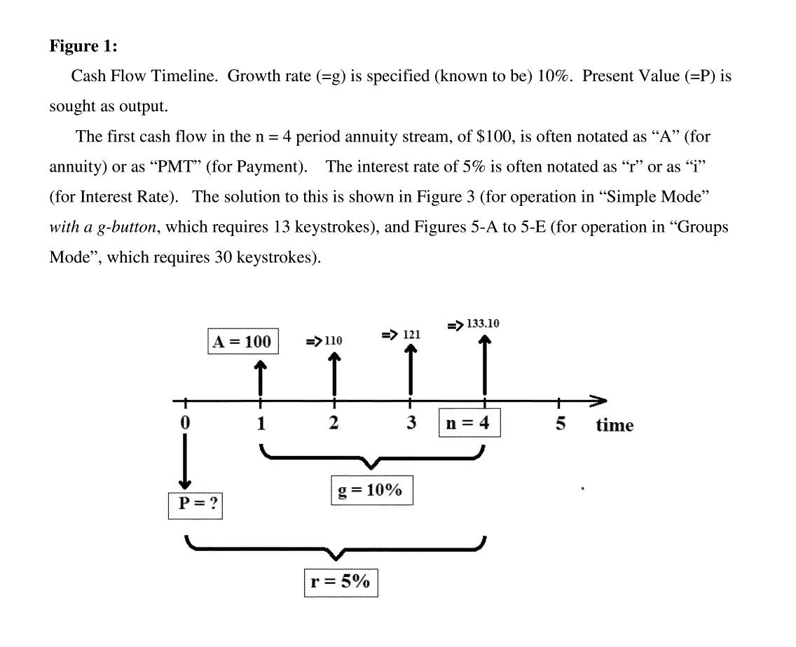

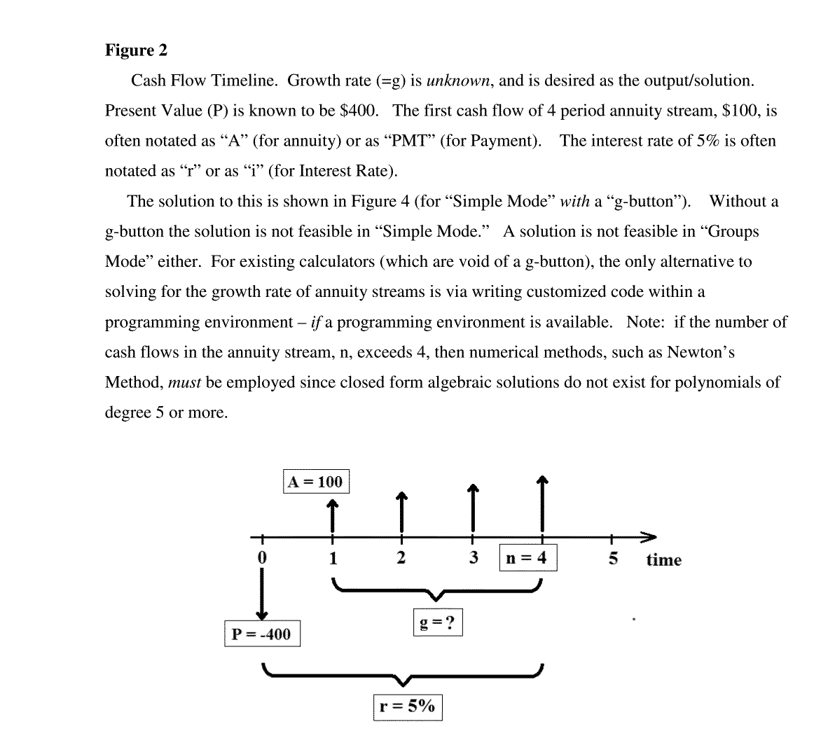

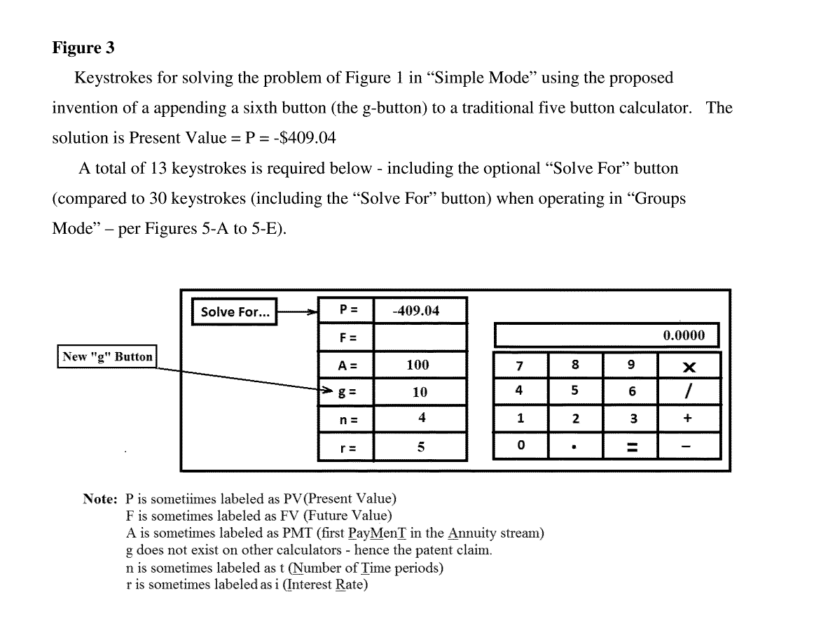

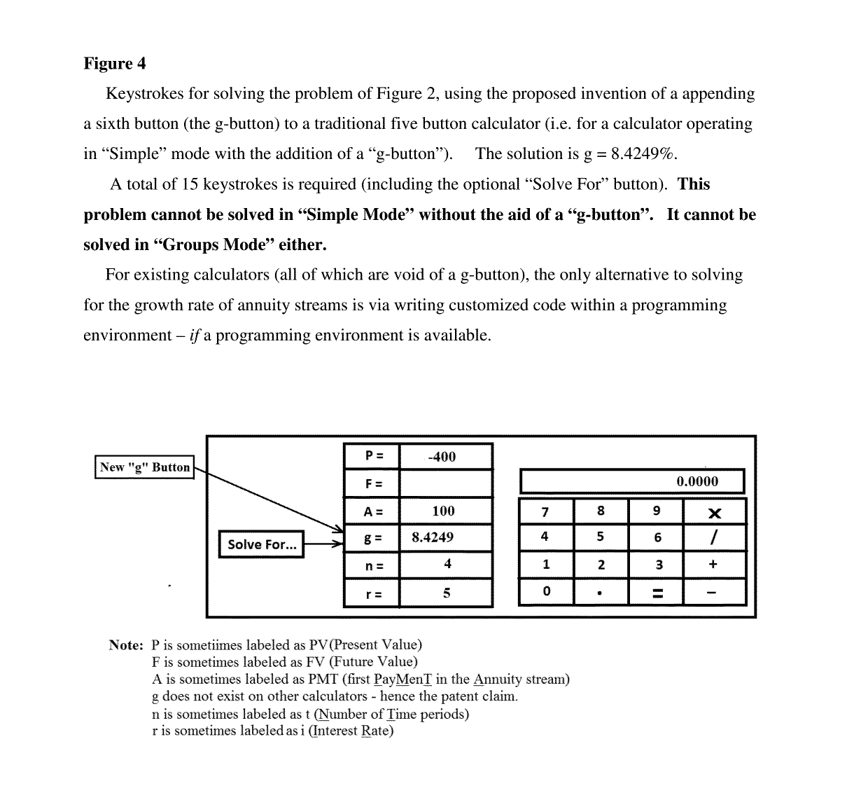

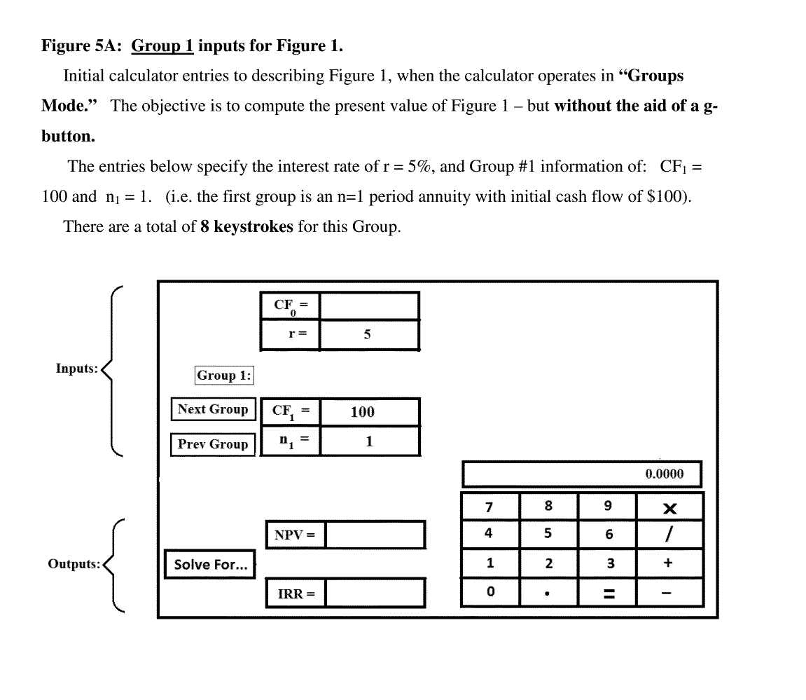

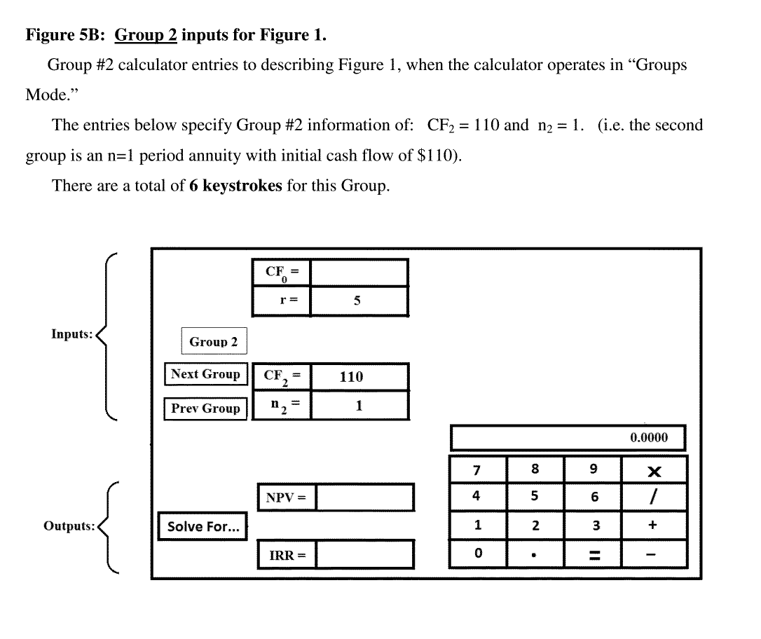

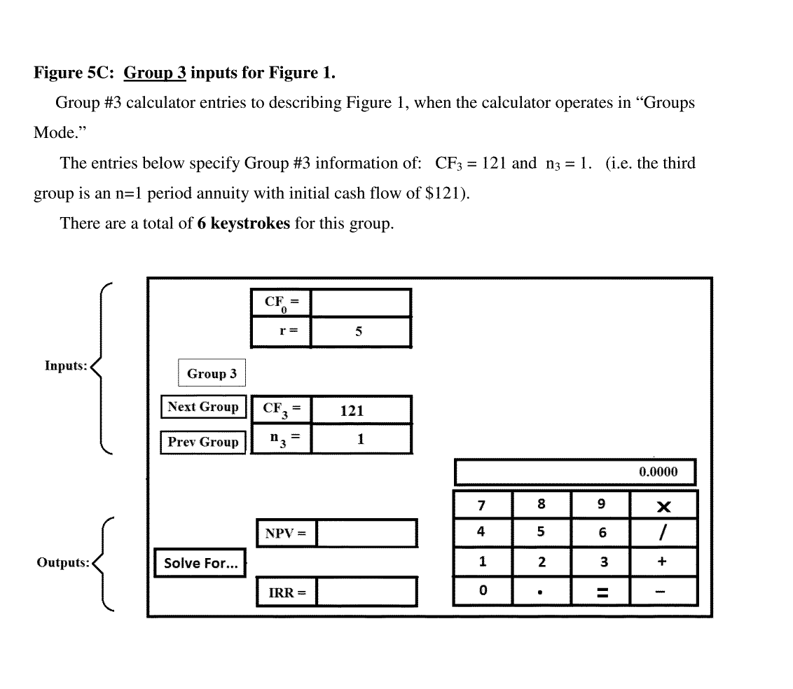

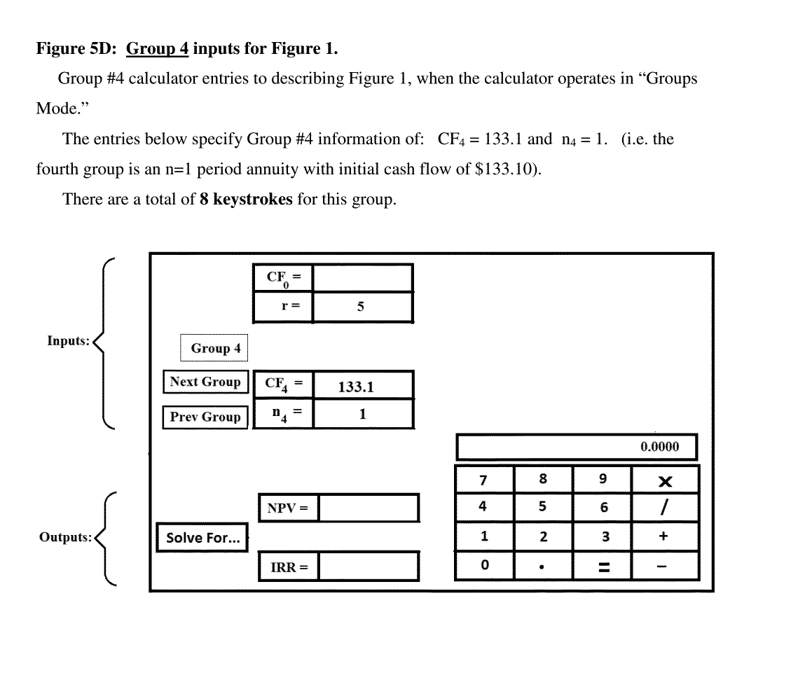

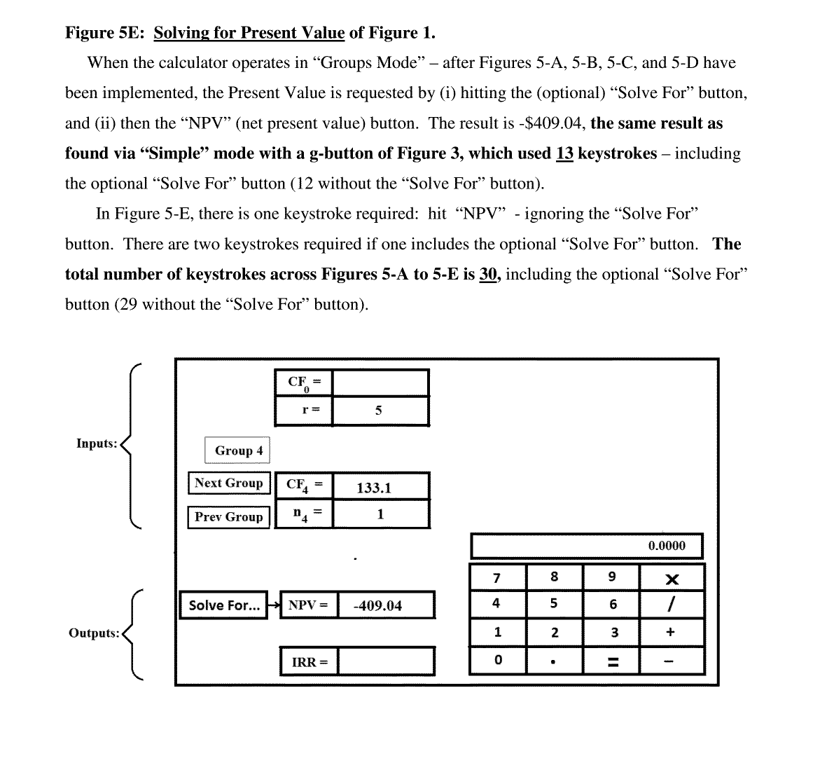

Financial calculators can be generally categorized into one of two types:
Those with only a single mode of operation—which we refer to as a “Simple 5-Button Mode”—because these in this mode of operation, the simple problems are solved via using five buttons representing (1) present value, (2) future value, (3) interest rate, (4) number of periods, and (5) the size of the first cash flow in the annuity stream.
   All exiting financial calculators employ five buttons in “Simple Mode”—and hence we refer to this mode as “Simple 5-Button Mode”.
Those with both a “Simple 5-Button Mode” and a “Groups” mode.
   With the HP 12C calculator, the “Groups” mode is often referred to, amongst practitioners, as the “CF-j” mode, (due to the labeling of the HP 12-C buttons) which means the Cash Flows of group J.
      Detailed instructions for operating the HP 12C in the CF-j mode can be found in the User Manual to the HP-12C, Section 4, page 57, found here: http://www.hp.com/ctg/Manual/c00363319.pdf
      In “Groups” mode, more complex problems can be analyzed. The “Groups” mode allows the user to specify several different individual cash flows of different sizes. Hence the 4 period growing annuity stream of FIG. 1 can be entered as 4 groups, where each group represents a single cash flow. In the HP 12C, the group numbers are indexed by j, and as such j runs from j=1 to j=4.

Most of the traditional “physical” calculators (such as those produced by Hewlett Packard, Texas Instruments, Sharp, etc) are of the second variety. That is, they have two modes of operation—the “Simple 5-button mode” and the “Groups” mode.

Many of the smart device oriented “virtual” calculators, typically distributed as “Apps” operate in the first mode only—the “Simple 5-button mode”.

In the “Simple 5-button mode”, a financial calculator is focused around five buttons. The HP 12C labels these five buttons as:
n—for the number of cash flows in the annuity stream
i—(sometimes labeled as “r”) for the Interest Rate used in present value and future value computations
PV—(sometimes labeled as “P”) for the Present Value of the subsequent cash flows.
PMT—(sometimes labeled as “A”)—for the first PayMenT in an Annuity stream
FV—(sometimes labeled as “F”) for the Future Value of the previous cash flows.

The invention augments the five buttons of the “Simple 5-button mode”, with a sixth “g-button”, labeled “g” for Growth rate. Hence, when operating in Simple Mode, the invention expands the number of available buttons (used to specify the problem and/or request a solution) from five buttons to six buttons. FIGS. 2 and 4—viewed together—demonstrate how a “Simple 6-Button” calculator is used to determine the implied growth rate of an annuity stream. In this problem the values of the present value (P=−400, 5 keystrokes), the length of the annuity (n=4, 2 keystrokes), the size of the first cash flow in the annuity stream (A=100, 4 keystrokes), and the interest rate (r=5%, 2 keystrokes) are specified, and the growth rate is solved for (1 or 2 keystrokes including the optional “Solve For” button), giving g=8.4249% (with decimal equivalent of 0.084249). For this “solve for g” scenario, the number of keystrokes totals only 15 (including the optional “Solve For” button). Calculators which lack an internal programming environment cannot solve this problem at all. Calculators such as the HP 12C can solve this problem—via employing the supplied internal programming environment—but the number of keystrokes required to do so far exceeds 15.

Now consider FIG. 1 in which the constant growth rate is known to be 10%, and the present value is requested as an output. For five button calculators (i.e. those without a g-button) that operate only in “Simple 5-button mode” (such as a typical smart-device App), the Present Value cannot be determined because there is no mechanism to specify the size of the 2^{nd} cash flow of $110, the 3^{rd} cash flow of $121, and the 4^{th} cash flow of $133.10. For these “Simple-mode only” calculators, the addition of a g-button, specified to equal 10%, easily solves the problem, as shown in FIG. 3 (with a solution of P=$409.04). Essentially, the additional information (conveyed by the g-button) of g=10%—which requires 3 keystrokes, (along with the information of n=4, and A=100—per the n-button and the A-button—for an additional 6 keystrokes) provides sufficient information for the financial calculator to infer the size of the 2^{nd}, 3^{rd}, and 4^{th} cash flows to be $110, $121, and $133.10 by using a total of only 9 keystrokes.

For calculators that also have the capacity to operate in “Group” mode, the Present Value of FIG. 1 can be solved for, but only by employing extensive keystrokes, dedicated to explicitly specifying each of the four cash flows that comprise the annuity stream, while the calculator is operating in “Group Mode.” For example FIGS. 5A through 5E depict the 29 keystrokes that are required to solve the problem depicted in FIG. 1 while operating in “Group Mode.” However, if a g-button is appended to the five buttons of Simple mode, then the number of keystrokes is reduced from 29 in “Groups” mode (as detailed in paragraphs [0024] to [0028]) to 12 keystrokes in “Simple” mode—with a g-button. For problems involving annuities with a dozen or more cash flows, the reduction is far more dramatic on both an absolute and relative (percentage reduction) basis. Hence, the addition of a g-button in “Simple mode” (expanding the calculator from a five button to a six button layout) results in substantial, and often dramatic reductions in the number of keystrokes employed when specifying a problem involving non-zero constant growth rate annuities.

FIGS. 5A to 5E demonstrate the required keystrokes in order to solve FIG. 1 while operating a conventional calculator in “Groups Mode.” More specifically in FIG. 5A, a total of 8 keystrokes are required as follows: In order to enter the interest rate of 5% the user must hit the “r” button, then type 5—for a total of 2 keystrokes. In order to enter the size of the cash flows in Group #1 (which consists of the $100 cash flow at time 1) the user must hit the CF₁ button and then type 100 (4 more keystrokes)—followed by hitting the n₁ button, and typing 1 (2 keystrokes). These 8 keystrokes complete the description of the first cash flow group (which is comprised of n₁=1 cash flow(s) of size CF₁=$100).

FIG. 5B, depicts the entries for Group #2 which requires a total of 6 keystrokes. In order to enter the size of the cash flows in Group #2 (which consists of the $110 cash flow at time 2) the user must hit the CF₂ button and then type 110 (4 keystrokes)—followed by hitting the n₂ button, and typing 1 (2 more keystrokes). These 6 keystrokes complete the description of the second cash flow group (which is comprised of n₂=1 cash flow(s) of size CF₂=$110).

FIG. 5C, depicts the entries for Group #3 which requires a total of 6 keystrokes. In order to enter the size of the cash flows in Group #3 (which consists of the $121 cash flow at time 3) the user must hit the CF₃ button and then type 121 (4 keystrokes)—followed by hitting the n₃ button, and typing 1 (2 more keystrokes). These 6 keystrokes complete the description of the third cash flow group (which is comprised of n₃=1 cash flow(s) of size CF₃=$121).

FIG. 5D, depicts the entries for Group #4 which requires a total of 8 keystrokes. In order to enter the size of the cash flows in Group #4 (which consists of the $133.10 cash flow at time 3) the user must hit the CF₄ button and then type 133.1 (6 keystrokes)—followed by hitting the n₄ button, and typing 1 (2 more keystrokes). These 8 keystrokes complete the description of the fourth cash flow group (which is comprised of n₄=1 cash flow(s) of size CF₄=$133.10).

Finally, FIG. 5E depicts the request for the Present Value of the four groups of cash flows using an interest rate of 5%. Ignoring the optional “Solve For” button, this requires only one keystroke—hitting the NPV (net present value) button. The result is a present value of $409.04—after a total of 29 keystrokes (=8+6+6+8+1)—ignoring the optional “Solve For” button. This is the same present value that was obtained in FIG. 3 using the Simple Mode with a g-button, but required only 12 keystrokes—a 58.6% reduction in keystrokes from 29. If a 30 year mortgage with monthly payments (360 monthly payments) were analyzed in real terms with an inflation rate of 3% per year (0.25% per month) the reduction in keystrokes is well in excess of 99%.

Regarding how to build the invention, the invention is easy to build by anyone with relatively modest levels of training in finance and computer science. The patent application author has built a working prototype (that by the time a patent reviewer reads this, should be available online at www.7button.com). Visually, the only new item to build is a “g-button” which is easily constructed from a composite material—possibly a plastic—with the letter “g” inscribed and/or painted on to, in the same method by which existing buttons are currently constructed on calculators such as the HP 12C and the TI BA-II Plus. For a virtual button, as might be found on a smart-device App, the “g-button” can be implemented as touch-sensitive image of the letter g.

As mentioned earlier, the “Solve For” button is an optional button that is not needed to operate a financial calculator, and hence it need not be built. If the “Solve For” button is omitted (as on the HP 12C), then the g-button is used to solve for the growth rate whenever it is pressed, only if a numeric value was not entered via the keypad immediately before the g-button was pressed. This is how the HP 12C operates.

For example, for a zero growth rate annuity consisting of four payments of $100 each, using an interest rate of 5%, the present value is found on an HP 12C as follows:
Clear the financial (FIN) registers via pressing the yellow f-button, followed by the CLEAR FIN button.
Type 100 and press the A-button (labeled PMT on the HP 12C)
Type 5 and press the r-button (labeled i on the HP 12C)
Type 4, and press the n-button
Then (without typing any numeric values) request that the present value be found by pressing the P-button (labeled as PV on the HP 12C)
The result, found without a “Solve For” button, is displayed to be 354.5950504.

When the invention's g-button is pressed so that the unknown growth rate is requested (i.e. when the growth rate is to be solved for), a memory controller supplies a solution algorithm with sufficient financial variables (such as P, A, n, r, and F) so that it can compute the implied growth rate—which is then reported to a display screen. Alternatively, when the g-button is used to specify the value of a known growth rate, a memory controller assigns the value of growth (maybe 0.05=5%) to a specific memory location which stores the value. Later, when a request for computation occurs (for example, if the computation of the present value is requested by the user) then the value of the growth rate is retrieved from memory by the memory controller and supplied to the solution algorithm, which in turn computes the requested variable (for example, present value) and sends the result to a display screen.

Regarding how to build an algorithm for determining the value of any requested output variable (i.e. building the “solution engine” for a calculator operating in “Simple mode” with a sixth “g-button” appended)—the following approach may be adopted.
Write the NPV (net present value) equation (which includes all cash flows on the timeline) and set it equal to zero. This gives one equation, and one unknown—the unknown variable to be solved for.
The NPV equation is then solved for the unknown variable (via numerical methods, or closed form solutions if they exist)
The unknown variable may or may not be the growth rate, which gives rise to two situations.

In the first situation the value of the growth rate is known, and therefore “g” is specified as an input via specifying the numeric value and hitting the g-button. In this case, the requested value (the output) is something other than g—such as the number of periods, n, the interest rate, r (or “i”), the present value, P, the first cash flow in the annuity stream, PMT (or “A”), or the future value, F. For some requests, such as present value, the computation of the requested variable is exact and straight forward (i.e. it is of a “closed form” solution)—for example see FIGS. 1 and 3 where the computation of the present value is the result of a well established closed form solution. For other output requests, such as solving for the interest rate, i (or “r”), the solution to the NPV=0 equation is typically algebraically challenging. In this situation any of a wide variety of numerical methods can be employed to solve for the unknown variable. For example, several iterations of Newton's Method, a well known numerical method, will suffice to provide a solution for the unknown variable.

In the second situation, the value of the growth rate is unknown and therefore “g” is requested as an output—and all other financial variables are inputs. In this situation, the solution to the NPV=0 equation gives the constant growth rate. However, because “g” occurs throughout the NPV=0 equation, solving for the constant growth rate is typically algebraically challenging (especially if the number of cash flows in the annuity stream exceeds 4) and therefore (as before) any of a host of numerical methods can be employed. For example, several iterations of Newton's Method, will suffice to provide a solution for the constant growth rate, g. For example, the problem depicted in FIG. 2, and solved via a six button calculator (i.e. “Simple 5-button mode” plus a g-button) in FIG. 4 was actually solved via numerical methods on a prototype calculator.

1. A system and method for efficiently entering and storing information that is sufficient to subsequently compute the size of all individual cash flows that collectively comprise a multi-period, constant periodicity cash flow annuity stream characterized by non-zero constant growth, comprising:
[a] a numeric keypad in which numbers can be entered
[b] one or more display screens for visual display of numeric values entered via said numeric keypad
[c] electronic memory used to store numeric values
[d] a memory controller used to transfer numeric values from said screen to said electronic memory
[e] a button or other indicator to be activated by the user's finger, or activated by an electronic pointing device, used for activating said memory controller so that the numerical value representing the non-zero constant growth rate of the annuity stream, as shown on one of said display screens, is sent to said electronic memory
[f] a button or other indicator to be activated by the user's finger, or activated by an electronic pointing device, used for activating said memory controller so that the numerical value representing the total number of cash flows that comprise the annuity stream, as shown on one of said display screens, is sent to said electronic memory
[g] a button or other indicator to be activated by the user's finger, or activated by an electronic pointing device, used for activating said memory controller so that the numerical value representing the size of the first cash flow in the annuity stream, as shown on one of said display screens, is sent to said electronic memory
whereby the total number of keystrokes required by the invention to sufficiently describe all cash flows that comprise the annuity stream is reduced, relative to directly entering, by use of a numeric keypad, the value of each cash flow in the annuity stream.

2. A system and method for efficiently determining the implied growth rate of a multi-period, constant periodicity cash flow annuity stream characterized by non-zero constant growth, comprising:
[a] an algorithm for determining the value of the unknown non-zero constant growth rate of the annuity stream using information on financial variables that describe cash flow timeline which represents the problem to be solved
[b] electronic memory used to store numeric values
[c] a memory controller used to transfer numeric values from said electronic memory to said algorithm
[d] a button or other indicator to be pressed by the user's finger, or activated by an electronic pointing device, used for requesting that said memory controller send the values of all required financial variables to said algorithm, and requesting that said algorithm be activated
[e] a display screen for visual display of the resulting growth rate, as supplied by said algorithm
whereby the total number of keystrokes required to solve for the non-zero, constant growth rate of the annuity stream is reduced, relative to the number of keystrokes required to solve the problem when the computational device operates in Groups mode, also known as CF-j mode.

3. A system and method for efficiently determining the implied growth rate of a multi-period, constant periodicity cash flow annuity stream characterized by non-zero constant growth, comprising:
[a] an algorithm for determining the value of the unknown non-zero constant growth rate of the annuity stream using information on financial variables that describe cash flow timeline which represents the problem to be solved
[b] electronic memory used to store numeric values
[c] a memory controller used to transfer numeric values from said electronic memory to said algorithm
[d] a button or other indicator to be pressed by the user's finger, or activated by an electronic pointing device, used for requesting that said memory controller send the values of all required financial variables to said algorithm, and requesting that said algorithm be activated
[e] a display screen for visual display of the resulting growth rate, as supplied by said algorithm
whereby all existing financial calculators operating in Simple 5-Button Mode, which are all incapable of solving for the non-zero constant growth rate, are functionally transformed via the addition of components [a] through [e] such that they are subsequently capable of determining the non-zero constant growth rate of an annuity stream.
